(19) United States
(12) Patent Application Publication
(10) Pub. No.: US 2008/0000212 A1
(43) Pub. Date: Jan. 3, 2008

(54) PICK UP ELEMENT FOR AGRICULTURAL PRODUCTS HAVING A THIN AND LONG-LIMBED SHAPE SUCH AS GRASS, STRAW, LEGUMINOUS AND SIMILAR PRODUCTS, AND A PICK UP DEVICE EXPLOITING THE SAME

(75) Inventor: Raffaele Ubaldi, Santa Giustina (Rimini) (IT)

Correspondence Address: PEARNE & GORDON LLP, 1801 EAST 9TH STREET, SUITE 1200, CLEVELAND, OH, 44114-3108, US

(73) Assignee: Denis Ubaldi, Santa Giustina (Rimini) (IT)

(21) Appl. No.: 11/768,080

(22) Filed: Jun. 25, 2007

(30) Foreign Application Priority Data
Jul. 3, 2006 (IT) RN2006A000046

(51) Int. Cl. A01D 89/00

(52) U.S. Cl. 56/364

(57) ABSTRACT

A pick up element (1) for agricultural products having a thin and long-limbed shape such as grass, straw, leguminous and similar products comprises long-limbed pick up prongs (10) developing along a development line (11) between a first and a second end (110,111) and ideally divided, along the development line (11) into: a taking up zone (100) of the agricultural products from the ground comprising the first end (110); a transport zone (101) of the agricultural products consecutive to the taking up zone (100) wherein the development line (11) defines a holding and transport concavity (112) of the agricultural products; a hooking zone (102) consecutive to the transport zone (101) and comprising the second end (111). A pick up device (2) comprises a plurality of said pick up elements (1) for agricultural products moved by a driving system (21) each along a closed trajectory with the transport concavities (112) turned towards the same direction (116) of movement of the prongs (10), and inclined with respect to bands (22) placed side by side so that during the motion of the prongs (10) along a transport segment of the closed trajectory the agricultural product tends to move away from the bands (22) and to accumulate in the holding and transport concavity (112), facilitating the release of the agricultural product from the prongs (10) at the release point.

### BACKGROUND OF THE INVENTION

The subject of this invention is a pick up element for agricultural products having a thin and long-limbed shape such as grass, straw, leguminous and similar products, and a pick up device exploiting the same.

Pick up devices are usually used for picking up from the ground, grass, straw, hay (which have been previously cut by other machines) or for picking up leguminous; anyway for picking up similar agricultural products (generally vegetables), having a long-limbed shape.

To this purpose they are coupled to a tractive unit (like a tractor or a self-propelled agricultural machine) which tows them.

Common pick up devices have a preferential direction of development which, during use, is kept transversal to the shifting direction of the tractive unit. In order to lift the agricultural products from the ground and move them (before unloading), these pick up devices use and are combined to a plurality of pick up elements which are moved by a driving system. The driving system is generally operated by a universal joint or the like which, through a power take-off, takes driving power from the tractive unit engine.

Each pick up element is in turn equipped with one or more prongs placed side by side. The pick up elements (and the respective prongs) are generally arranged around the preferential direction of development along rows, which are parallel to the preferential direction of development itself. Each pick up element (and its prongs) is moved by the driving system along a closed trajectory which surrounds the preferential direction of development. The prongs are straight elements, one end of which is hooked (directly or through some parts of the pick up element) to the driving system, while the opposite end is free. Ideally every prong can be divided into three zones: a zone of product taking up, which corresponds to the free end and is the zone which comes first into contact with the product during harvesting; a zone of product transport, consecutive to the taking up zone, having a size larger than the latter; an hooking zone, consecutive to the transport zone, intended for hooking to the driving system. The transport zone is a straight segment. The taking up zone is also a straight segment which can lie on the same lying straight line of the transport zone or it can be slightly inclined with respect to the latter. A plurality of bands placed side by side, fixed to the driving system with respect to the pick up elements, surrounds the preferential direction of development at least in correspondence with a section of the closed trajectory. This trajectory section corresponds to the lifting of the agricultural product from the ground and to the transport of it, through the prongs, up to the product unloading point which is placed along the closed trajectory itself. This plurality of bands defines a covering surface of the driving system, which prevents the agricultural product from falling inside during transport. Every band is placed between two prongs which are consecutive to each other along the preferential direction of development. Between two consecutive bands a space is provided to let each prong freely move along the closed trajectory.

Prongs stretch out towards outside the space delimited by the covering surface, the lying straight line of the transport zone being substantially perpendicular to the covering surface itself.

Generally a row of prongs acts as a rotating rake, which comes first into contact with the product through the taking up zone and lifts it up. Then the product is intercepted by the transport zone which carries it up to a point where it has to be unloaded.

The pick up devices and pick up elements described above have some drawbacks.

In particular, during the motion from the point where the product is lifted up from the ground to the product unloading point, the product itself tends to accumulate against the bands. This favours product infiltration in the space between one band and the other (necessary for the prong movement), thus getting the area of the driving system dirty. Besides, even the product unloading itself becomes difficult.

### SUMMARY OF THE INVENTION

The present invention aims at removing the above mentioned drawbacks, providing a pick up element for agricultural products having a thin and long-limbed shape such as grass, straw, leguminous and similar products that, thanks to its configuration, after being properly hooked to a pick up device, allows an optimum unloading of the product and avoids product infiltration in the area where the driving system is placed.

The present invention also aims at providing a pick up device exploiting a pick up element for agricultural products having a thin and long-limbed shape such as grass, straw, leguminous and similar products according to the invention, the pick up device, which, properly mounting the pick up element, allows an optimum unloading of the product and avoids product infiltration in the area where the driving system is placed.

These aims, and others beside, which will be more apparent in the following description, are reached, according to the present invention, by a pick up element for agricultural products having a thin and long-limbed shape such as grass, straw, leguminous and similar products and by a pick up device exploiting the same which have structural and functional features in accordance with the independent claims herein, further embodiments of the same being described by the corresponding dependent claims herein.

### BRIEF DESCRIPTION OF THE DRAWINGS

The invention is described in more detail below with reference to the accompanying drawings, which represent a preferred and non-limiting embodiment.

FIG. 1 shows a side view and a plan view of a first embodiment of a pick up element according to the invention, comprising only a prong for the sake of simplicity and by way of a (not limitative) example.

FIG. 2 shows a side view and a plan view of a second embodiment of a pick up element according to the invention, comprising only a prong for the sake of simplicity and by way of a mere (not limitative) example.

FIG. 3 shows a side view and a plan view of a pick up element according to the prior-art, comprising only a prong for the sake of simplicity and by way of a mere (not limitative) example.

FIG. 4 shows a perspective and schematic view of a pick up device according to the invention;

FIG. 5 shows a cross-section view, with some parts removed the better to highlight others, of the pick up device of FIG. 4.

FIG. 6 shows an enlarged detail marked by a circle in FIG. 5.

### DESCRIPTION OF THE PREFERRED EMBODIMENTS

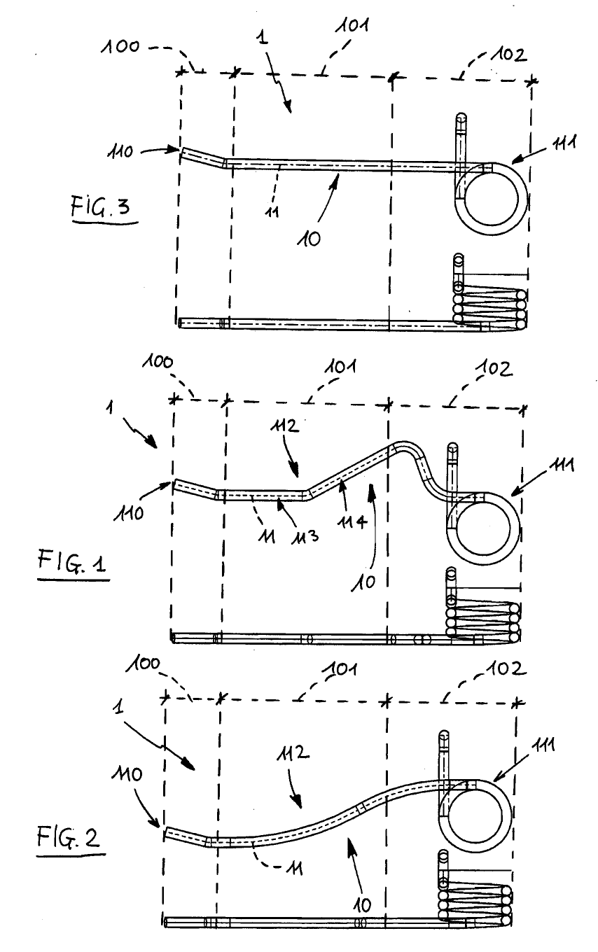

With reference to FIGS. 1 and 2, a pick up element 1 for agricultural products having a thin and long-limbed shape such as grass, straw, leguminous and similar products, which can be used in pick up devices 2 according to the invention, comprises at least one long-limbed pick up prong 10 developing along a development line 11 between a first and a second end 110, 111. As shown in the figures by reference dashed lines, the prong 10 is ideally divided, along the development line 11 into:
a taking up zone 100 of agricultural products from the ground comprising the first end 110;
a transport zone 101 of agricultural products consecutive to the taking up zone 100;
a hooking zone 102 consecutive to the transport zone 101 and comprising the second end 111.

The hooking zone 102 is intended for hooking to a pick up device 2, directly or by means of some hooking parts of the pick up element 1.

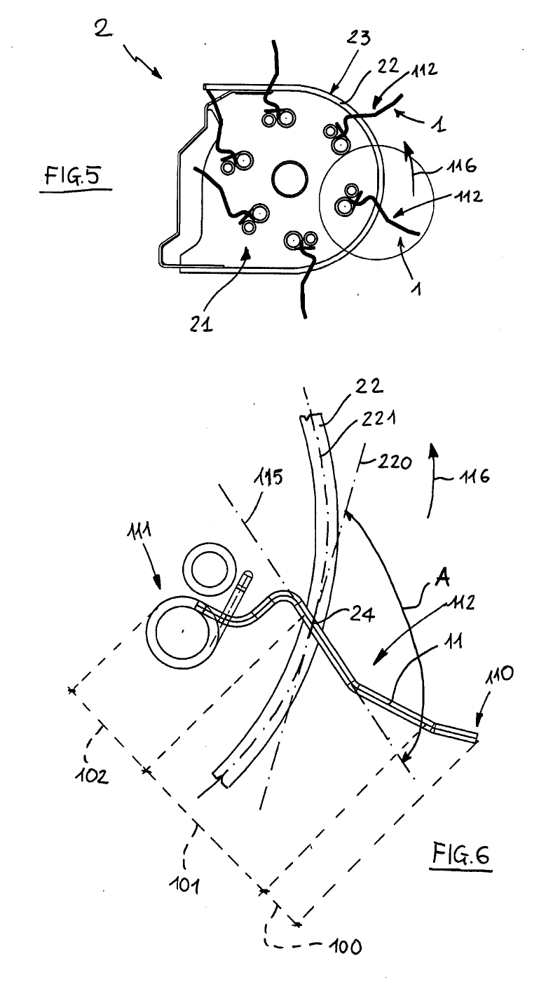

As shown in FIGS. 1, 2 and also visible in FIGS. 5 and 6, in the transport area 101 of the prong 10 of the pick up element 1 according to the invention, the development line 11 defines a holding and transport concavity 112 of agricultural products.

This constitutes a substantial difference from the prong 10 of the prior art shown in FIG. 3, which, on the contrary, has a development line 11 lying on a single straight line along the whole of the transport zone 101 (and also along the taking up zone 100).

Thanks to this difference, when the pick up element 1, according to the invention, is properly mounted on a pick up device 2, the product tends to accumulate in the holding and transport concavity 112 and not in the hooking area 102.

As illustrated in FIG. 2, in the transport zone 101 the development line 11 may be curvilinear without any straight segment. Alternatively, at least part of the holding and transport concavity 112 is defined by a broken line (see FIG. 1, where this holds for the whole portion of the development line 11 which defines the holding and transport concavity 112).

In particular, as illustrated in FIG. 1, the broken line is defined by a first 113 and a second 114 segment. Any way the broken line may be defined also by more than two segments. At least two of the segments forming the broken line may be joined together by a curved portion (as shown in FIG. 1).

In an embodiment of the invention the meeting point between the first 113 and the second 114 segment is less far from the hooking zone 102 than from the taking up zone 100. Even if for the sake of simplicity the figures show pick up elements 1 provided, by way of example, with only one prong 10, according to the invention the pick up element 1 may comprise two or more identical prongs 10 placed side by side. Such prongs 10 may be made integral to one another by (not illustrated) connecting means provided with hooking parts to a pick up element 2. The specific shape of the prong 10 in the hooking area 102 is not essential for the invention ultimate aim: this shape is generally determined by the internal features of the pick up device 2 whereon the pick up element 1 shall be mounted and can contemplate (as partly illustrated in the figures) spiral parts working as springs to allow an elastic strain of pick up elements 1 during operation.

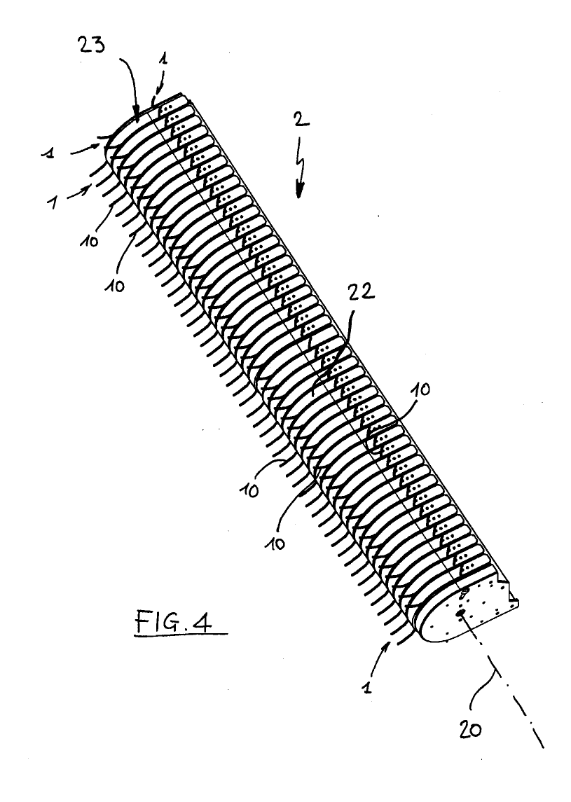

With reference to FIGS. 4, 5, 6, a pick up device 2 for agricultural products having a thin and long-limbed shape such as grass, straw, leguminous and similar products, of the type which can be dragged by a tractive unit and has a preferential direction 20 of development which, during use, is kept transversal to the shifting direction of the tractive unit, comprises a plurality of pick up elements 1 of agricultural products, each of them provided with at least one long-limbed pick up prong 10. Besides, the pick up device 2 comprises a driving system 21 of every pick up element 1 along a closed trajectory surrounding the preferential direction 20 of development, the closed trajectory comprising a transport segment of the agricultural product between a taking up point of the product from the ground by the long-limbed prongs 10 and a release point of the agricultural product by the long-limbed prongs 10, once arrived in correspondence with the release point the prong 10 not having a transport function of the agricultural product any more. Moreover, the pick up device 2 comprises a plurality of bands 22 placed side by side, fixed to the driving system 21 with respect to the pick up elements 1 and surrounding the preferential direction 20 of development at least in correspondence with the transport segment of the closed trajectory. The plurality of bands 22 placed side by side defines a surface 23 of at least partial covering of the driving system 21. Each band is placed between two long-limbed prongs 10 which are consecutive to each other along the preferential direction 20 of development and between two consecutive bands 22 a space is provided to let each long-limbed prong freely move along the preferential direction 20 of development.

The pick up elements 1 are pick up elements 1 according to the invention and made according to any one of the embodiments and possibilities previously described in the description of pick up elements 1 according to the invention. In the pick up device 2 according to the invention, during the motion of the prongs 10 along the whole of the transport segment of the closed trajectory:
the hooking area 102 of each prong 10 remains inside the surface 23 of at least partial covering of the driving system 21;
the holding and transport concavity 112 is turned towards the same direction 116 of movement of the prongs 10 along the closed trajectory and is inclined with respect to the bands 22 so that during the motion of the prongs 10 along the transport segment of the closed trajectory from the taking up point to the release point the agricultural product tends to move away from the bands 22 and to accumulate in the holding and transport concavity 112, facilitating the release of the agricultural product from the prongs 10 at the release point.

In a preferred embodiment of the pick up device 2 according to the invention, during the motion of the prongs 10 along the whole of the transport segment of the closed trajectory:
the development line 11 of every prong 10 intersects the surface 23 of at least partial covering in a point 24 of intersection which corresponds to a point of the transport zone 101 of the prong 10;
the tangent 115 to the development line 11 of each prong 10 in the point of intersection 24 and the tangent 220 to a development line 221 of each band 22 adjacent to it in the same point of intersection 24 form between them, outside the surface 23 of at least partial covering and on the side towards which the transport concavity 112 is turned to, an angle A greater than 90 degrees;

during the motion of the prong 10 along the transport segment of the closed trajectory from the taking up point to the release point the agricultural product tends to move away from the bands 22 and to accumulate in the transport concavity 112, facilitating the release of the agricultural product from the prongs 10 at the release point.

Opportunely the angle A is greater than 110 degrees. Opportunely, the angle A is smaller than 170 degrees. Preferably the angle A is comprised between 120 and 140 degrees.

The invention has some important advantages.

First of all the product, having the tendency to stay confined in the holding and transport concavity 112, does not stand on the bands 22 and then it takes less the risk to filter into the sheltered area wherein the driving system 21 lies, thus avoiding gears and mechanisms getting dirty or obstructing because of product infiltration. Moreover, once the prongs 10 reach the release point, the complete product unloading is much easier and made in an easy way, without any problems.

The invention as it has been conceived, is susceptible of several modifications and variants, all of them being part of the inventive concept characterizing the invention.

Furthermore, all details are replaceable by other technically equivalent elements. In practice, all the employed materials, as well as dimensions, can be any one, according to requirements.

What is claimed:

1. Pick up element for agricultural products having a thin and long-limbed shape such as grass, straw, leguminous and similar products, of the type which can be used in pick up devices, comprising at least one long-limbed pick up prong developing along a development line between a first and a second end, the prong being ideally divided along the development line into:
a taking up zone of agricultural products from the ground comprising the first end;
a transport zone of agricultural products consecutive to the taking up zone;
a hooking zone consecutive to the transport zone, comprising the second end and intended for hooking to a pick up device, directly or by means of hooking parts of the pick up element;
wherein in the transport zone the development line defines a holding and transport concavity of the agricultural products.

2. Pick up element according to claim 1, wherein at least part of the holding and transport concavity is defined by a broken line.

3. Pick up element according to claim 2, wherein the broken line is defined by a first and a second segment.

4. Pick up element according to claim 3, wherein the meeting point between the first and the second segment is less far from the hooking zone than from the taking up zone.

5. Pick up element according to claim 2, wherein at least two of the segments forming the broken line are joined together by a curved portion.

6. Pick up element according to claim 1, comprising two or more identical prongs placed side by side.

7. A pick up device for agricultural products having a thin and long-limbed shape such as grass, straw, leguminous and similar products, of the type which can be dragged by a tractive unit and has a preferential direction of development which, during use, is kept transversal to the shifting direction of the tractive unit, comprising:
a plurality of pick up elements of agricultural products, each of them provided with at least one long-limbed pick up prong;
a driving system of every pick up element along a closed trajectory surrounding the preferential direction of development, the closed trajectory comprising a transport segment of the agricultural product between a taking up point of the product from the ground by the long-limbed prongs and a release point of the agricultural product by the long-limbed prongs, once arrived in correspondence with the release point the prong not having a transport function of the agricultural product any more;
a plurality of bands placed side by side, fixed to the driving system with respect to the pick up elements and surrounding the preferential direction of development at least in correspondence with the transport segment of the closed trajectory to define a surface of at least partial covering of the driving system, each band being placed between two long-limbed prongs which are consecutive to each other along the preferential direction of development, a space being provided between two consecutive bands to let each long-limbed prong freely move around the preferential direction of development;
wherein:
each long-limbed pick up prong develops along a development line between a first and a second end, the prong being ideally divided along the development line into: a taking up zone of agricultural products from the ground comprising the first end; a transport zone of agricultural products consecutive to the taking up zone, the development line defining, in the transport zone, a holding and transport concavity of the agricultural products; a hooking zone consecutive to the transport zone, comprising the second end and hooked to the pick up device, directly or by means of hooking parts of the pick up element;
and wherein, during the motion of the prongs along the whole of the transport segment of the closed trajectory:
the hooking zone of each prong remains inside the surface of at least partial covering of the driving system;
the holding and transport concavity is turned towards the same direction of movement of the prongs along the closed trajectory and is inclined with respect to the bands so that during the motion of the prongs along the transport segment of the closed trajectory from the taking up point to the release point the agricultural product tends to move away from the bands and to accumulate in the holding and transport concavity, facilitating the release of the agricultural product from the prongs at the release point.

8. Pick up device according to claim 7, wherein, during the motion of the prongs along the whole of the transport segment of the closed trajectory:
the development line of every prong intersects the surface of at least partial covering in a point of intersection which corresponds to a point of the transport zone of the prong;
the tangent to the development line of each prong in the point of intersection and the tangent to a development line of each band adjacent to it at the same point of intersection form between them, outside the surface of at least partial covering and on the side towards which the transport concavity is turned to, an angle greater than 90 degrees;
during the motion of the prong along the transport segment of the closed trajectory from the taking up point to the release point the agricultural product tending to move away from the bands and to accumulate in the transport concavity, facilitating the release of the agricultural product from the prongs at the release point.

9. Pick up device according to claim 8, wherein the angle is greater than 110 degrees.

10. Pick up device according to claim 8, wherein the angle is comprised between 120 and 140 degrees.

11. Pick up device according to claim 8, wherein the angle is smaller than 170 degrees.

12. Pick up device according to claim 7, wherein at least part of the holding and transport concavity is defined by a broken line.

13. Pick up device according to claim 12, wherein the broken line is defined by a first and a second segment.

14. Pick up device according to claim 13, wherein the meeting point between the first and the second segment is less far from the hooking zone than from the taking up zone.

15. Pick up device according to claim 12, wherein at least two of the segments forming the broken line are joined together by a curved portion.

16. Pick up device according to claim 7, wherein it comprises two or more identical prongs placed side by side.
